(19) United States
(12) Patent Application Publication
(10) Pub. No.: US 2017/0219126 A1
(43) Pub. Date: Aug. 3, 2017

(54) CLIP, A CLAMP ASSEMBLY, AND A MOUNTING STRUCTURE

(71) Applicant: NEWFREY LLC, New Britain, CT (US)

(72) Inventor: Hiroyuki KATO, Utsunomiya-shi (JP)

(21) Appl. No.: 15/414,121

(22) Filed: Jan. 24, 2017

(30) Foreign Application Priority Data
Feb. 2, 2016 (JP) 2016-017677

(51) Int. Cl. F16L 3/13; F16L 3/223; F16B 2/22; B60R 16/08; B60R 16/02

(52) U.S. Cl. CPC F16L 3/13; B60R 16/08; B60R 16/0215; F16B 2/22; F16L 3/2235

(57) ABSTRACT

A clip includes a cylindrical pipe clamp portion which is formed with an open portion that is open in the axial direction; insert guide plates which extend from both ends of the pipe clamp portion in the circumferential direction so as to widen obliquely upwards; a slip-preventing plate which extends widthwise from the end of the pipe clamp portion in the axial direction; and raised stoppers which are contiguous with both ends of the outer circumferential surface of the pipe clamp portion, and also extend in the axial direction. One slip-preventing plate extends in one widthwise direction from one axial end of the pipe clamp portion, and another slip-preventing plate extends in the opposite direction, from the other end of the pipe clamp portion.

### CROSS-REFERENCE TO RELATED APPLICATION

This application claims priority from Japanese Patent Application No. 2016-017677, filed on Feb. 2, 2016, the entire disclosure of which is incorporated herein by reference.

### BACKGROUND OF THE INVENTION

The present invention pertains to a clip that is an auxiliary clamp device used with a clamp; to a clamp assembly comprised of a clamp and a clip; and to a mounting structure, for holding a long and narrow tubular part such as a pipe, a tube, or a wire harness on a workpiece such as an auto body panel or the like.

A clamp for mounting a tubular part such as a pipe or the like to a workpiece is provided with a clamp which holds the part, and a locking component which is secured to the workpiece, such as an auto body panel or the like. The clamp holds the pipe, and the locking component is secured to the workpiece. The upper part of the clamp has an open portion for receiving the pipe, and houses the pipe in a U-shaped space formed by a pair of side walls and a bottom portion. The pipe is held so that it is does not fall out of the clamp. The locking component has a securing means for attaching to a workpiece such as a body panel, which enables it to be secured to an auto body panel, or the like.

In general, this sort of clamp is sent to the auto manufacturer with the pipe already mounted in a predetermined position and angle by the pipe manufacturer. There are instances in which the position and angle of the pipe relative to the clamp become defective during shipment of the pipe or the like, if the force with which the clamp is mounted to the pipe is weak. Consequently, a horizontal slip or rotation of the pipe occurs. As a result, the mounting position or the angle of the clamp must be adjusted when the pipe is attached to the panel on the assembly line of the auto manufacturer, and this can require extra work, delaying the assembly.

Also, if one attempts to use a clamp to attach a soft tubular part such as a plastic tube or the like to a panel, a clamp with a cover must be used because the plastic tube or the like can be damaged.

Furthermore, a separate clamp must be used if the thicknesses of the pipes are different. As a result, a different clamp must be manufactured for each pipe.

Examples of existing pipes will be explained by referring to FIGS. 1A-3C. FIG. 1A is a front elevational view of an existing clamp 1. Clamp 1 is provided with a clamp portion for holding a pipe P1, and a locking portion which is secured to a workpiece such as an auto body panel or the like. The clamp portion of Clamp 1 has a main body 2. A groove with a cross-sectional U shape is formed in main body 2 as the housing 3. The clamp portion has a pair of prongs 4 which extend obliquely downward from the top end of main body 2. Protuberances 5 are formed on the bottom surface of main body 2, which abut the surface of the panel when mounting to the panel (the workpiece). The locking portion at the bottom of the clamp portion has a columnar support portion 6 which extends downward from the center of main body 2, and locking legs 7 which extend obliquely upward from the tips of columnar support portion 6, for attaching to the attaching hole of the workpiece.

The diameter of the pipe P1 is φp1. The top and the bottom of housing 3 of clamp 1 are linear, and the top and the bottom are bounded by a curve.

The distance W1 between the opposing inner surfaces of housing 3 is slightly smaller than the diameter φp1 of pipe P1, so that pipe P1 is mated by pushing it into housing 3. That is, μp1>W1. In this way, clamp 1 is held so that it does not slip or rotate relative to pipe P1. The distance between the tips of prongs 4 is A.

FIG. 1B is a front elevational view which shows pipe P1 mounted in clamp 1 (Deformation Example 1). The diameter φp1 of pipe P1 is larger than distance W1 between the opposing inner surfaces of housing 3; and pipe P1 is mated by firmly pushing it into housing 3.

As a result, the top of housing 3 of clamp 1 undergoes deformation so as to open in the direction of arrows J. The distance between the tips of the pair of prongs 4 is increased from A to A′; and the tips of prongs 4 no longer contact pipe P1. As a result, the force which holds the pipe is also reduced. Pipe P1 contacts the bottom and side walls of housing 3 along a line which extends in the axial direction of P1, at the positions [S] shown in the diagram. As a result, pipe P1 easily slips horizontally or rotates.

FIG. 1C is another front elevational view which shows pipe P1 mounted in clamp 1 (Deformation Example 2). If housing 3 of clamp 1 undergoes deformation so that housing 3 opens at the top, both ends of main body 2 of clamp 1 deform downward in the direction of arrows K, and protuberances 5 on the bottom surface of main body 2 move downward from the center, over the distance B only.

The lower ends of protuberances 5 are designed so that they abut the top surface of the panel, and the tips 7a of locking legs 7 enter the attaching hole of the panel. The distance from the lower ends of protuberances 5 to the base of the tips of locking legs 7 is designed to be equal to the thickness of the panel. The concern exists that if protuberances 5 move downward, the tips 7a of locking legs 7 cannot be inserted into the attaching hole of the panel as far as their bases.

FIG. 1D is a front elevational view which shows three pipes P1 mounted in a clamp 1b which is formed with three housings. (Deformation Example 3). When three pipes P1 are mounted, housing 3b of clamp 1b undergoes deformation so that the top opens. The distance from the center between middle pipe P1 to the pipes on either end is larger than normal by the distance [D] only. The pipes on both ends move downward relative to the center pipe by the distance [C] only. As more pipes P1 are mounted, their dimensions at the ends of clamp 1b change greatly.

Both ends of main body 2b of clamp 1b undergo deformation so as to be bent downward in the direction of arrows K. Protuberances 56 on the bottom of main body 2b move downward from their original position. Both ends of main body 2b hang downwards; and as a result, it becomes difficult to insert tips 7a of locking legs 7 into the attaching hole of a panel.

FIG. 2A is a front elevational view of another existing clamp 1C. FIG. 2B is a cross-sectional diagram along line E-E in FIG. 2A. The housing 3c of clamp 1c is an arcuate curve. The inner diameter of housing 3c is φk1. A leaf spring 8 is placed on the bottom of housing 3c. Leaf spring 8 is connected to main body 2 by its center portion, and extends obliquely upward from its center towards the ends of the pipe in the axial direction; and by pinning down pipe P1 by means of spring action, pipe P1 does not slip horizontally or rotate. Clamp 1c is identical to clamp 1, except that it has spring 8.

FIG. 2C is a front elevational view which shows pipe P1 mounted in clamp 1c, and FIG. 2D is a cross-sectional diagram along line F-F in FIG. 2C. The ends of leaf spring 8 abut the outer circumferential surface of Pipe P1. However, if the strength of leaf spring 8 is excessive, clamp 1c will undergo deformation. For this reason, the strength of leaf spring 8 must be in a range such that pipe P1 does not undergo deformation. As shown in FIG. 2D, only the tips of leaf spring 8 contact pipe P1. Also, the area of prongs 4 that contacts pipe P1 is small. As a result, pipe P1 can easily slip horizontally or rotate, even with clamp 1c which has leaf spring 8.

Next, the mounting of a soft plastic tube or rubber hose to clamp 1 will be explained. FIG. 3A is a front elevational view which shows a soft plastic tube T1 mounted to clamp 1. When plastic tube T1 is mounted to clamp 1, it is compressed by the three side surfaces of housing 3 and by prongs 4, and undergoes deformation. As a result, the force which secures plastic tube T1 is weak.

Clamp 1 is usually formed from a hard plastic such as polyacetal or the like, and, as a result, clamp 1 is harder than the plastic tube T1 which is to be mounted. Also, only prongs 4 compress the top part. As a result, plastic tube T1 can be damaged.

FIG. 3B is a front elevational view which shows a soft plastic tube T1 mounted in clamp 1d, which has a cover 9. FIG. 3C is a cross-sectional diagram along line G-G in FIG. 3B. When a clamp 1d with a cover used, housing 3d is an arcuate shape which follows the outer diameter of plastic tube T1. If a soft plastic tube T1 is mounted using a clamp 1d with a cover 9, plastic tube T1 does not undergo deformation and fall out, even though it is not pressed into the housing.

However, in a clamp with a cover securing a plurality of pipes, if the thicknesses or the spacing of the pipes varies, a separate clamp and cover are needed, and metal molds must be made for both the separate clamp and the cover.

As a result, when a component such as a pipe or the like is mounted to a clamp, an auxiliary clamp device is sought that can keep the clamp from slipping horizontally or rotating relative to the pipe.

Also, an auxiliary clamp device is sought which can use the same clamp as often as possible, even though the size and pitch of the component vary.

Patent Reference 1 discloses a pipe securing device having an insulator attached to the outer circumferential surface of a pipe and a clamp for inserting the insulator. To secure the pipe, the pipe is inserted into a pipe insertion aperture by pressing down and widening a slit on the insulator, and a ring-shaped band is engaged in a locking component and fastened to the outer circumferential surface of the pipe. When the insulator attached to the pipe is inserted in a receiving portion of the clamp, a projecting tab of the clamp engages in the insulator to prevent it from falling out.

The pipe securing device of Patent Reference 1 has vibration damping and a binding action over the entire circumference of the pipe.

However, although the insulator is held along its circumference by means of the receiving portion and the projecting tab of the clamp, there is no means for preventing the insulator from slipping relative to the clamp. As a result, slipping and rotation of the pipe securing device can occur if the pipe is shipped with the insulator and the clamp already mounted to the pipe.

Patent Reference 2 discloses a clip device for use with pipes that has a semi-circular groove clamping a pipe in the same position as the contacting opposing surfaces of a clip main component and a clip auxiliary component. A pair of flexible arcuate tabs is formed on the top and bottom of the opening of the semicircular groove of the clip main component, which are continuous with the circumferential surface of the semicircular groove. This clip for use with a pipe in Patent Reference 2 can also attach a small diameter pipe by means of a spacer that is attached in the semicircular groove.

The clip device for use with a pipe described in Patent Reference 2 can also hold pipes having different diameters such that they do not become loose.

However, if this clip device for use with a pipe is shipped with the pipe already attached, the clip device can slip and rotate.

For this reason, a clip is sought which can function as an auxiliary clamp device that can be mounted after a component such as a pipe or the like has been attached, without damaging the pipe and such that the clamp does not slip horizontally or rotate relative to the pipe.

Also, a clip is sought which can be mounted to a clamp used for a hard pipe without damaging a soft tubular component, such as a plastic tube or the like.

Further, a clip is sought in which the same clamp can be used when components with different outer diameters are mounted.

### PATENT REFERENCES

Patent Reference 1—Unexamined Utility Model Publication 63-8488

Patent Reference 2—Unexamined Patent Publication H7-198069

### SUMMARY OF THE INVENTION

One object of the present invention is to offer a clip used in combination with a clamp; wherein, once a clip and a clamp have been mounted to a component such as a pipe or the like, the pipe is not damaged, and the clip does not slip horizontally or rotate relative to the pipe and the clamp.

Another object of the present invention is to offer a clip that can attach a soft, tubular component such as a plastic tube or the like to a clamp used for a hard pipe, without damaging the component.

An additional object of the present invention is to offer a clip which can use the same clamp when mounting components with different diameters.

Still another object of the present invention is to offer a clip assembly which is assembled from a clamp, and the clip of the present invention.

The present invention is an auxiliary clamp device used in combination with a clamp to hold a tubular part. The pipe clamp portion of the clip is cylindrical and is formed with an open portion that is open along the axial direction. Insert guide plates extend from the end of the pipe clamp portion in the circumferential direction so as to widen obliquely upward. Slip-preventing plates extend widthwise from the ends of the pipe clamp portion in the axial direction.

The first embodiment of the present invention is a clip which is used in combination with a clamp for holding a tubular component and is characterized by the fact that it is provided with a cylindrical pipe clamp portion formed with an open portion which is open along the axial direction; one or a pair of insert guide plates which extend from the ends of the pipe clamp portion in the circumferential direction, so as to widen obliquely upward; and at least one slip-preventing plate which extends widthwise from the ends of the pipe clamp portion in the axial direction.

If the pipe clamp portion is cylindrical and part of it is formed with an open portion which is open along the axial direction, a component such as a pipe or the like can be held in the pipe clamp portion.

If insert guide plates extend from the ends of the pipe clamp portion in the circumferential direction so as to widen obliquely upwards, the component is made to abut between the insert guide plates, and the component is pressed down into the pipe clamp portion.

If at least one slip-preventing plate extends widthwise from the end of the pipe clamp portion in the axial direction, the clip is held so that it does not slip horizontally relative to the clamp.

It is desirable to have a pair of slip-preventing plates, with one slip-preventing plate extending in one widthwise direction from one end of the pipe clamp portion in the axial direction, and another slip-preventing plate extending in the opposite direction from the other end of the pipe clamp portion in the axial direction.

If a pair of slip-preventing plates is provided and one slip-preventing plate extends from one end of the pipe clamp portion in the axial direction, and the other slip-preventing plate extends in the opposite direction from the other end of the pipe clamp portion in the axial direction, the clip is held so that it does not slip horizontally relative to the clamp.

There may be two pairs of slip-preventing plates. One pair of slip-preventing plates can extend widthwise in both directions from one end of the pipe clamp portion in the axial direction, and another pair of slip-preventing plates can extend widthwise in both directions from the other end of the pipe clamp portion in the axial direction.

Moreover, there may be three slip-preventing plates. One pair of slip-preventing plates may extend widthwise in both directions from one end of the pipe clamp portion in the axial direction, and one separate slip-preventing plate can extend widthwise in both directions from the other end of the pipe clamp portion in the axial direction.

It is preferable to provide one or a pair of raised stoppers which are contiguous with both ends of the circumferential surface of the pipe clamp portion and which extend in the axial direction.

If raised stoppers which are contiguous with both ends of the circumferential surface of the pipe clamp portion and extend in the axial direction are provided, the tips of the prongs of the clamp abut the stoppers, and it is possible to prevent the pipe from falling out.

There may be three or more stoppers, distributed along the axial direction.

It is desirable to form a plurality of raised ribs on the outer circumferential surface of the pipe clamp portion which extend in the axial direction. If a plurality of raised ribs that extend in the axial direction is formed on the outer circumferential surface of the pipe clamp portion, and the outer diameter of the ribs is made to conform to the inner diameter of the housing of the clamp, pipes with a small outer diameter can be mounted, if a clip for pipes with a small outer diameter is used in combination with the same, shared clamp.

The second embodiment of the present invention is a clamp assembly for holding a tubular part, which is provided with a clamp, and a clip which is held in the housing of the clamp; wherein the clamp has a main body formed with one or a plurality of housings; one or a pair of prongs which extend from the end of the housing obliquely downward towards the housing; and a locking portion for attaching to a workpiece; and wherein the clip has a cylindrical pipe clamp portion formed with an open portion that is open along the axial direction; one or a pair of insert guide plates that extend from the ends of the pipe clamp portion in the circumferential direction so as to widen obliquely upward; and at least one slip-preventing plate which extends widthwise from the end of the pipe clamp portion in the axial direction; and further wherein the pipe clamp portion of the clip is housed in a component housing portion of the clamp, and the outside bottom surfaces of the insert guide plates abut the inside top surfaces of the prongs of the clamp.

It is desirable for the insert guide plates of the clip to be compressed by the prongs of the clamp so that the open portion is narrowed.

If the insert guide plates of the clip are compressed by the prongs of the clamp so that the open portion is narrowed, the pipe can be securely mounted in the pipe clamp portion.

It is desirable for the clip to have at least two slip-preventing plates, with one slip-preventing plate abutting one end of the main body in the axial direction, and the other slip-preventing plate abutting the other end of the main body in the axial direction.

It is desirable for the tips of the prongs of the clamp to abut the stoppers of the clip, so that the open portion is held without widening.

If the tips of the prongs of the clamp abut the stoppers of the clip so that the open portion is held without widening, the clip does not fall out from the housing of the clamp.

It is desirable to form a plurality of raised ribs on the outer circumferential surface of the pipe clamp portion which extend in axial direction so that the tips of the ribs abut the inner surface of the housing of the clamp.

The third embodiment of the present invention is a mounting structure in which a tubular part is mounted by a clamp, and by a clip which is held in the housing of the clamp; wherein the clamp has a main body formed with one or a plurality of housings; one or a pair of prongs which extend from the end of the housing obliquely downward towards the housing; and a locking portion for attaching to a workpiece; and wherein the clip has a cylindrical pipe clamp portion which is formed with an open portion that is open along the axial direction; one or a pair of insert guide plates which extend from both ends of the pipe clamp portion in the circumferential direction so as to widen obliquely upward; and at least one slip-preventing plate which extends widthwise from the end of the pipe clamp portion in the axial direction; and wherein the pipe clamp portion of the clip is housed in the housing of the clamp, and the tubular part is held in the pipe clamp portion of the clip; the outside lower surfaces of the insert guide plates of the clip abut the inside top surfaces of the prongs of the clamp.

It is desirable for the inner diameter of the pipe clamp portion of the clip to be smaller than the outer diameter of the tubular part.

If the inner diameter of the pipe clamp portion of the clip is smaller than the outer diameter of the tubular part, the clip can hold the part tightly so that it does not slip horizontally relative to the clip.

The present invention offers a clip that is used in combination with a clamp; after the clip and the clamp have been mounted to a pipe, the pipe component or the like is not damaged, and the clip does not slip or rotate relative to the component and the clamp.

Furthermore, the present invention offers a clip in which a soft tubular part such as a plastic tube or the like can be mounted to a clamp used for a hard pipe without damaging the tubular part.

Another object of the present invention is to offer a clip in which the same clamp can be used to mount components with different outer diameters.

The present invention also offers a clamp assembly which is assembled from a clamp, and the clip of the present invention.

### BRIEF DESCRIPTION OF THE DRAWINGS

FIG. 1A is a front elevational view of an existing clamp.

FIG. 1B is a front elevational view of a pipe mounted to the clamp in FIG. 1A.

FIG. 1C is another front elevational view of a pipe mounted to the clamp in FIG. 1A.

FIG. 1D is a front elevational view of pipes mounted to a clamp, in which three pipes have been mounted to the clamp.

FIG. 2A is a front elevational view of another existing clamp.

FIG. 2B is a cross-sectional diagram of the clamp in FIG. 2A, along line E-E.

FIG. 2C is a front elevational view of a pipe mounted to the clamp in FIG. 2A.

FIG. 2D is a cross-sectional diagram along line F-F in FIG. 2C.

FIG. 3A is a front elevational view of a soft plastic tube mounted in an existing clamp.

FIG. 3B is a cross-sectional diagram of an existing clamp with a cover.

FIG. 3C is a cross-sectional diagram along line G-G of the clamp in FIG. 3B.

FIG. 4 is a top plan view of a clip according to a first embodiment of the present invention.

FIG. 5 is a front elevational view of the clip in FIG. 4.

FIG. 6 is a bottom plan view of the clip in FIG. 4

FIG. 7 is a left side elevational view of the clip in FIG. 4.

FIG. 8 is a right side elevational view of the clip in FIG. 4.

FIG. 9 is a front elevational view which shows the clip of FIG. 4 mounted to a pipe.

FIG. 10 is a top plan view which shows the clip of FIG. 4 and the clamp of the present invention mounted to a pipe.

FIG. 11 is a front elevational view of FIG. 10.

FIG. 12 is a bottom plan view of FIG. 10.

FIG. 13 is a left side elevational view of FIG. 10.

FIG. 14 is a right side elevational view of FIG. 10.

FIG. 15 is a front elevational view of a pipe with a small outer diameter, mounted using a clip of the second embodiment of the present invention.

FIG. 16 is a front elevational view, similar to that of FIG. 15, but showing a pipe with a large outer diameter, mounted using only the clamp of the present invention, and not the clip.

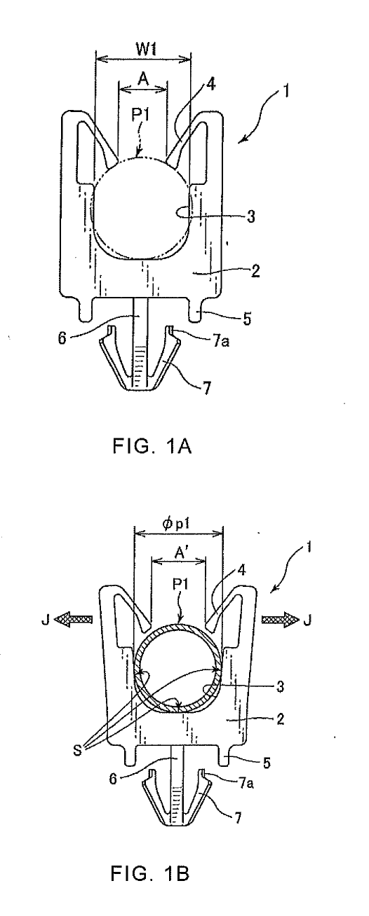

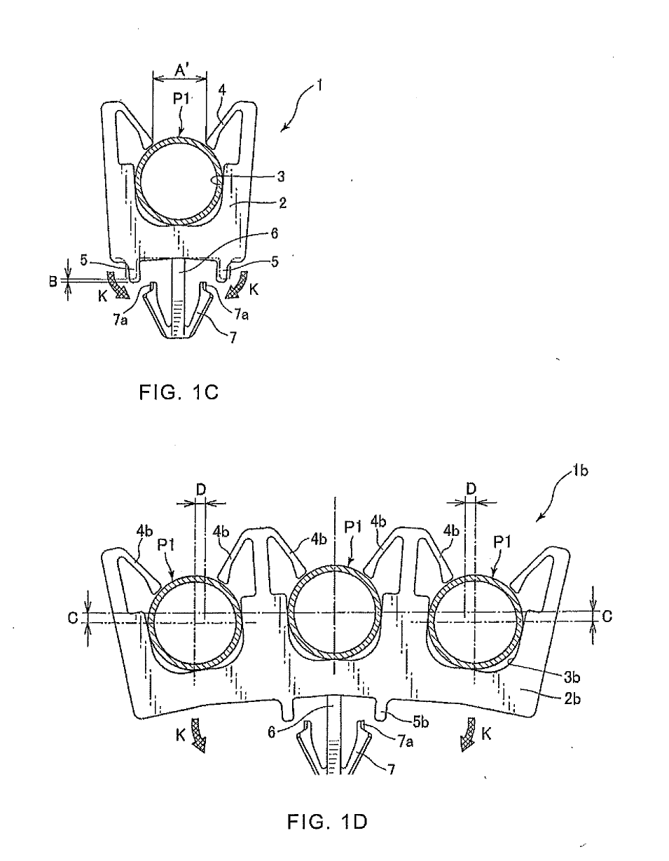

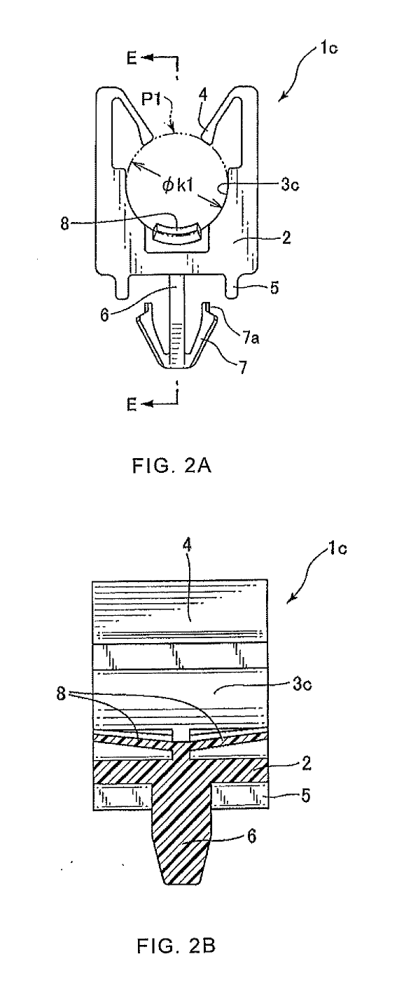

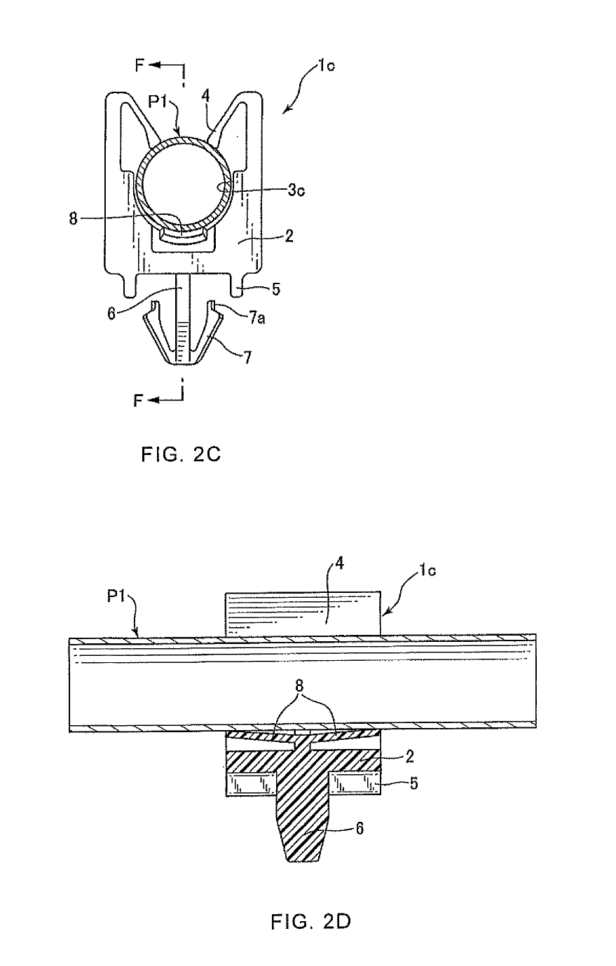

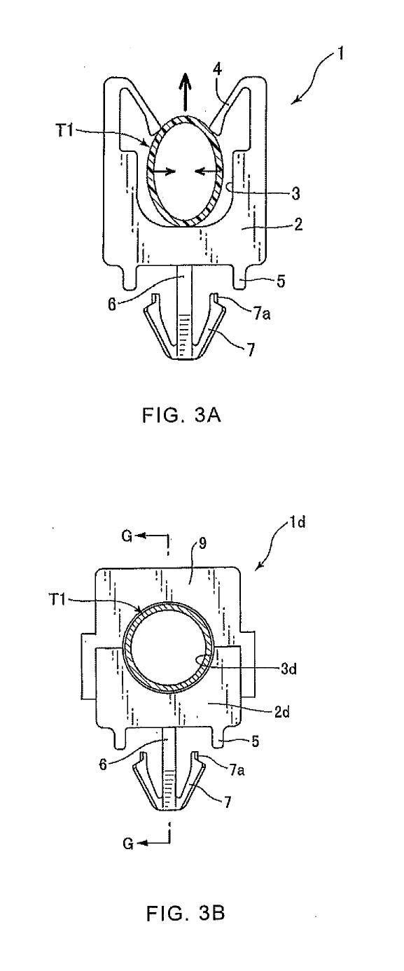

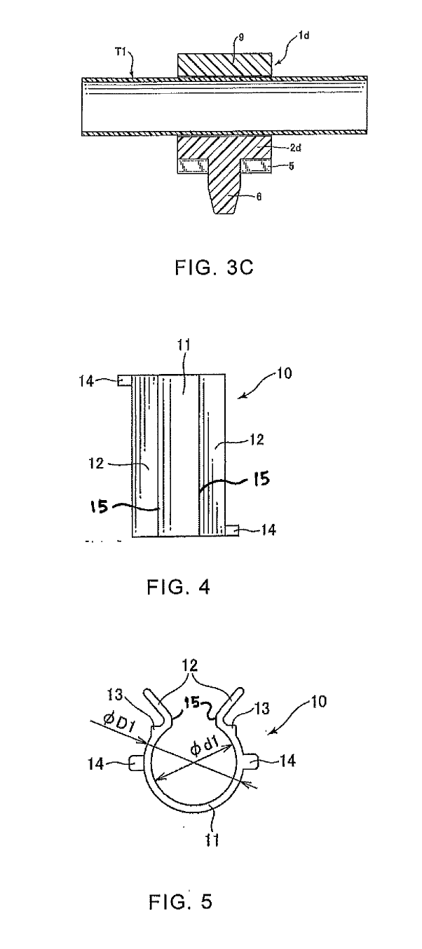

### DESCRIPTION OF THE PREFERRED EMBODIMENTS

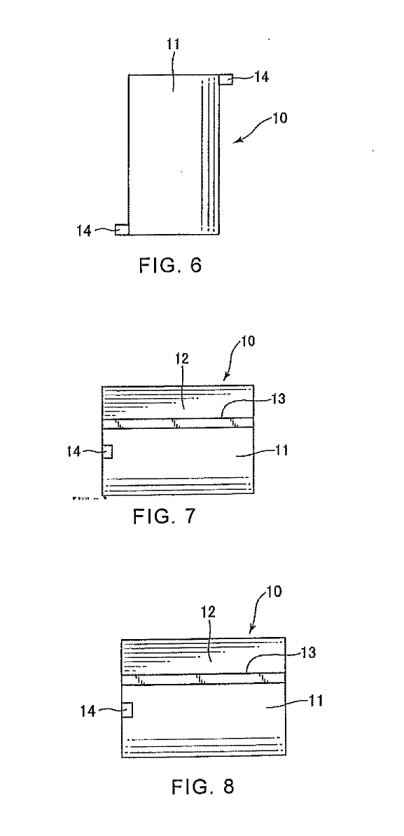

Next, a clip 10 of the first embodiment of the present invention will be explained by referring to the Drawings. FIG. 4 is a top plan view of clip 10 according to the first embodiment. FIG. 5 is a front elevational view of clip 10; FIG. 6 is a bottom plan view; FIG. 7 is a left side elevational view; and FIG. 8 is a right side elevational view.

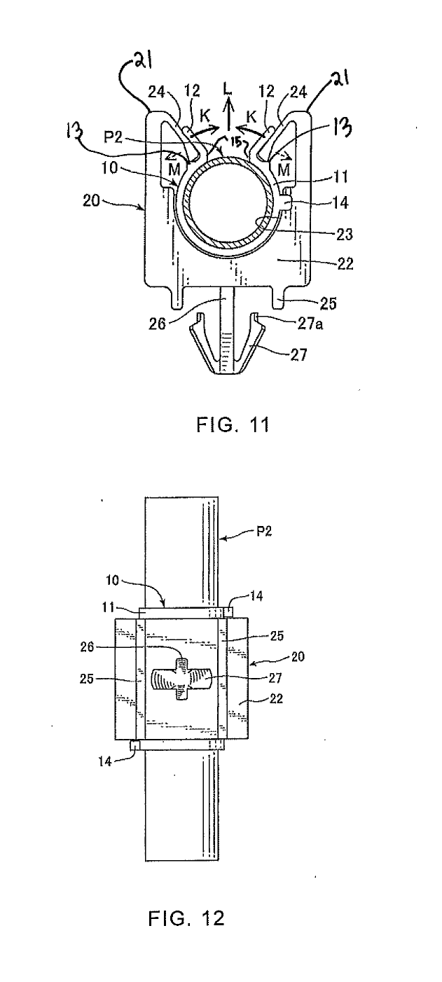

In the present Specification, the depth direction (the axial direction of the pipe) in FIGS. 5 and 11 will be called the depth direction. The upward direction in FIG. 5 will be called the upward direction; and the downward direction will be called the downward direction. The horizontal direction will be called the width direction.

Clip 10 is an auxiliary clamp device used with clamp 20 (see FIGS. 10-15), and is housed in the housing of the clamp, and holds a tubular part such as a pipe or the like. Clip 10 has a pipe clamp portion 11 which holds a tubular part such as a pipe or the like, by abutting the outer circumferential surface of the pipe. Pipe clamp portion 11 is cylindrical, and part of it, in the upward direction in FIG. 5, is open along the axial direction so that the pipe or component can be pushed from this opening into a component holding space inside pipe clamp portion 11. When clip 10 is in its ordinary state, the inner diameter of pipe clamp portion 11 is φd1. The outer diameter of pipe clamp portion 11 is φD1. The length of pipe clamp portion 11 in the axial direction is slightly longer than the length of the clamp 20 in the axial direction (see, for example, FIG. 10).

As shown in FIG. 5, a pair of insert guide plates 12 extends from the top of pipe clamp portion 11 adjacent respective circumferentially-opposed end portions 15 so as to widen obliquely upwardly or outwardly. The length of insert guide plates 12 in the axial direction is the same as the length of pipe clamp portion 11 in the axial direction. The configuration of insert guide plates 12 is substantially rectangular.

When the component is inserted in pipe clamp portion 11, if the component abuts insert guide plates 12 as it is pushed in, insert guide plates 12 separate from one another, enabling insertion of the component into pipe clamp portion 11.

In the first embodiment of the present invention, clip 10 has a pair of insert guide plates 12. Clip 10 is used in combination with clamp 20, which has a pair of prongs 24 (see, for example, FIG. 11).

In other embodiments, there may also be only one insert guide plate 12. In a clip 10 with one insert guide plate 12, the component is pushed in while it abuts between one insert guide plate 12 and the side surfaces of the clip on the other side. A clamp with one prong 24 is used mainly in combination with a clip having one insert guide plate 12.

Referring to FIGS. 5, 7 and 8, raised stoppers 13 extend in the axial direction, near the respective starting points of insert guide plates 12, which are on the top of pipe clamp portion 11 in FIG. 5. Prongs 24 of clamp 20 engage with stoppers 13, as will be described later.

In the first embodiment of the present invention, clip 10 has a pair of stoppers 13. Clip 10 is used in combination with clamp 20, which has a pair of prongs 24.

In other embodiments, there may be only one stopper 13. A clip with one stopper 13 is used mainly in combination with a clamp having one prong 24.

As shown in FIGS. 5, 7 and 8, one raised slip-preventing plate 14 is formed on one end of pipe clamp portion in the axial direction, so as to extend widthwise. Also as shown in FIGS. 5, 7 and 8, another raised slip-preventing plate 14 is formed on the other end of pipe clamp portion 11 in the axial direction, so as to extend in the other width direction. Slip-preventing plates 14 engage the ends of clamp 20 in the axial direction, and clip 10 is thus held so that it does not slip in the axial direction relative to clamp 20 (see FIGS. 10-15).

In the first embodiment of the present invention, clip 10 has a pair of slip-preventing plates 14.

In other embodiments, there may be only one slip-preventing plate 14, which is placed on one end of clip 10 in the axial direction only. Also, in still other embodiments, there may be four slip-preventing plates 14, with one pair placed on one end in the axial direction so as to extend widthwise towards both sides, and another pair of slip-preventing plates 14 placed on the other end in the axial direction so as to extend widthwise towards both sides. Furthermore, there may be three slip-preventing plates 14, with one pair of slip-preventing plates 14 placed on one end in the axial direction, and one slip-preventing plate 14 placed on the other end in the axial direction.

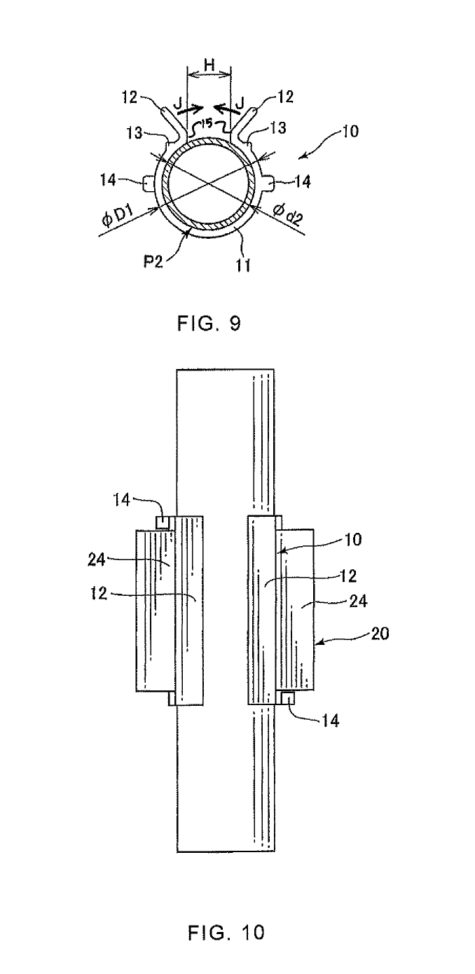

Next, clip 10 mounted on pipe P2 will be explained. FIG. 9 is a front elevational view which shows clip 10 mounted on pipe P2. The outer diameter of pipe P2 is φd2. More precisely, when dimensional tolerances are taken into account, the minimum outer diameter is φd2. The inner diameter φd1 of pipe clamp portion 11 when clip 10 is in its natural state (see FIG. 5) is smaller than the minimum diameter φd2 of pipe P2. That is, φd1<φd2.

When in the state shown in FIG. 9, the inner diameter of pipe clamp portion 11 widens more than φd1 and becomes approximately equal to outer diameter φd2 of pipe P2, because clip 10 holds pipe P2 which has the outer diameter φd2. When pipe P2 is held, the outer diameter of pipe clamp portion 11 becomes slightly larger than φD1, however. In FIG. 9, this is shown by φD1.

Still referring to FIG. 9, on clip 10, insert guide plates 12 exert a force that narrows the open portion or gap in the direction of arrows J in the diagram, and pipe clamp portion 11 is mated tightly with pipe P2, enabling pipe P2 to be held securely. The gap is the open portion bounded by insert guide plates 12 and pipe clamp portion 11.

When pipe P2 is in the held position, the gap is at a minimum width H.

Clip 10 abuts the outer circumferential surface of pipe P2 over a wide area of pipe clamp portion 11, with the exception of the open portion. The area of contact with pipe P2 is greatly increased, and the friction force is greatly improved, compared with pipe P2 being held by only the clamp 20.

If clip 10 is to be mounted to a soft plastic tube (or a rubber hose), the minimum width H is made smaller than the horizontal width of the plastic tube undergoing deformation. If clip 10 is mounted to a soft plastic tube, the same efficacy is obtained as if the clamped portion of the plastic tube had been rigid; even when mounted to clamp 20, there are no defects such as occur when the tube falls out or is damaged.

As a result, there is no need to use a clamp with a cover.

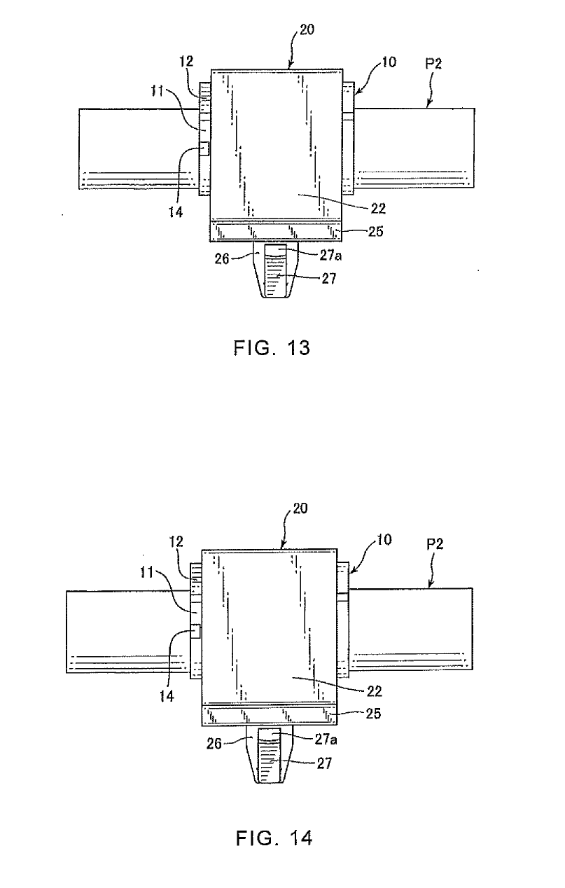

FIG. 10 is a top plan view of clip 10 and clamp 20 mounted to pipe P2. FIG. 11 is a front elevational view; FIG. 12 is a bottom plan view; FIG. 13 is a left side elevational view; and FIG. 14 is a right side elevational view.

As shown in FIG. 9, clip 10 is mounted to pipe P2; and next, as shown in FIG. 11, clamp 20 is attached to clip 10 that has been mounted to pipe P2.

Clip 10 mounted on clamp 20 is called “the clamp assembly.”

Next, clamp 20 will be explained. Clamp 20 is provided with a clamp portion which holds pipe P2 and a locking portion which secures to a workpiece, such as a body panel or the like. The clamp portion has a main body 22. The main body 22 defines a housing or channel 23, having a “U”-shaped cross-section. The bottom of the “U” has a semicircular cross-section. The inner diameter of housing or channel 23 is approximately equal to the outer diameter of pipe clamp portion 11 (which is approximately φD1) when pipe P2 is mounted in clip 10. Clip 10 and pipe P2 are mounted in housing 23. The main body 22 defines two top ends 21, each of which is formed on each side of the main body.

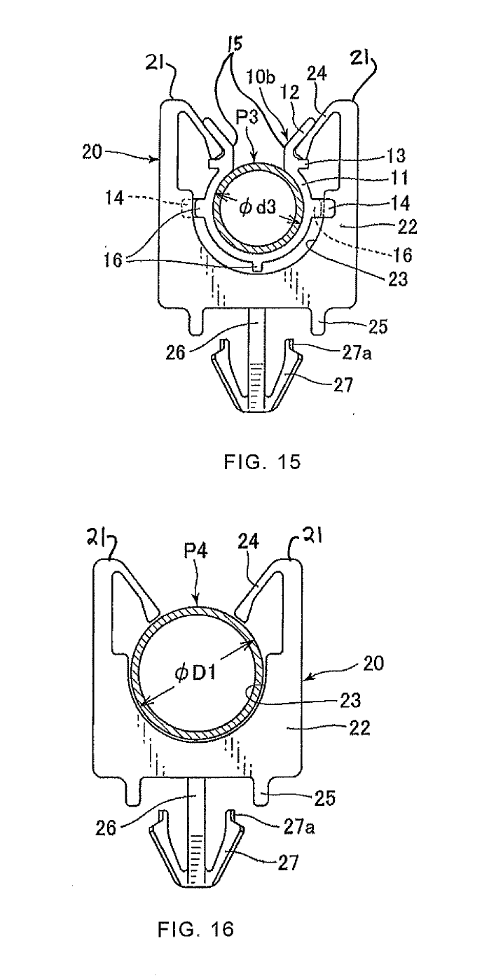

The main body 22 of clamp 20 has a pair of prongs 24, each of which extend obliquely downwardly (or radially inwardly) from each top end 21 of the main body, which prongs are formed on each side of main body 22. Prongs 24 abut the stoppers 13 which are formed on the outer circumference of pipe clamp portion 11 of clip 10, without directly abutting pipe P2 (FIGS. 11 and 15).

Protuberances 25 are formed on the bottom surface of main body 22, which abut the panel (the workpiece) when the panel is attached. The locking portion on the bottom of clamp 20 has a columnar portion 26 which extends downwardly from the center of main body 22, and a pair of locking legs 27 which extend from the tip of columnar portion 26 obliquely upwardly, for mounting in an attaching hole of the workpiece.

In the first embodiment of the present invention, clamp 20 has a pair of prongs 24.

In other embodiments, there may be only one prong 24. In a clamp 20 with one prong 24, the clip with the mounted component is pushed in and made to abut between one prong 24 and the side surface of clamp 20 on the other side. A clamp 20 with only one prong 24 is used mainly in combination with a clip 10 which has only one insert guide plate 12.

In the first embodiment of the present invention, the locking portion is comprised of a columnar portion 25 and locking legs 27, but the locking portion is not limited to this structure. In other embodiments, the locking portion may be anything that attaches clamp 20 to a workpiece, such as a panel or the like. Also, the locking portion may be a structure that attaches to a stud erected perpendicularly on the panel.

Next, referring to FIGS. 10-14, the process for mounting clip 10 with the attached pipe P2 to clamp 20 will be explained. The axial directions of clip 10 and clamp 20 are aligned, and main body 22 of clamp 20 is positioned so that it enters between slip-preventing plates 14 of clip 10. Pipe clamp portion 11 of clip 10 is made to abut on prongs 24 of clamp 20, and pipe clamp portion 11 is pushed in and housed in housing 23.

The tips of prongs 24 abut stoppers 13 and are thus held without widening. As a result, it is difficult to remove pipe P2 after clip 10 is mounted in clamp 20.

If there is only one prong 24, the pipe clamp portion is pushed in between one prong 24 and the surface of the housing on the other side.

As shown in FIG. 11, the outside lower surfaces of insert guide plates 12 abut the inside top surfaces of prongs 24. The slope of insert guide plates 12 and the slope of prongs 24 are approximately equal. The gap between the opposing surfaces of prongs 24 is made narrower than the gap between the outer surfaces of the pair of insert guide plates 12. As a result, a force is applied on insert guide plates 12 by means of prongs 24, which narrows the gap of the open portion of the clip 10 in the direction of arrows K. As shown in FIG. 9, clip 10 alone produces a force in the direction of arrows J, and when this force is combined with force K from prongs 24, pipe P2 can be held securely.

Insert guide plates 12 abut prongs 24, and as a result, clip 10 is held without rotating relative to clamp 20.

As shown in FIGS. 13 and 14, one slip-preventing plate 14 of clip 10 abuts on one surface of main body 22 of clamp 20 in the axial direction, and another slip-preventing plate 14 of clip 10 abuts on the other surface of main body 22 in the axial direction; clip 10 is thus held so that it does not slip horizontally relative to clamp 20.

If only one slip-preventing plate 14 is used, clip 10 can be held so that it does not slip horizontally in one direction. If two pairs of slip-preventing plates 14 are used, it can be held even more securely.

The length of prongs 24 is designed so that tips of prongs 24 abut stoppers 13 when pipe clamp portion 11 of clip 10 is placed in housing 23 of clamp 20.

As shown in FIG. 11, if a force L is applied to pipe P2 tending to pull out pipe P2, prongs 24 apply a counteracting force which moves along the outer circumference of clip 10 in the direction M. However, stoppers 13 abut at the tips of prongs 24, and prongs 24 cannot move in the direction M. As a result, clip 10 cannot be removed from housing 23 of clamp 20, and it is thus possible to prevent pipe P2 from being removed from pipe clamp portion 11 of clip 10.

Next, the method for mounting pipe P2 to a workpiece such as a panel or the like will be explained. Locking legs 27 of clamp 20 are inserted into the attaching hole of the panel. When the locking legs 27 are compressed by the inner circumferential surface of the attaching hole, the space between locking legs 27 becomes smaller, and locking legs 27 pass through the attaching hole. Protuberances 25 abut the surface of the panel; and clamp 20 is attached to the panel when the tips 27a of locking legs 27 engage in the inner circumference of the attaching hole.

Next, the mounting of pipes with different outer diameters will be explained. The outer diameter of pipe clamp portion 11 of clip 10 is equal to approximately φD1, and by changing the inner diameter of pipe clamp portion 11 to match the pipe, pipes having an outer diameter that is different from outer diameter φd2 can be attached.

If the outer diameter of the pipe to be attached does not vary too greatly from the outer diameter φd2 of pipe P2, this can be done by changing the inner diameter of pipe clamp portion 11, that is, by changing its thickness.

If the pipe to be attached has a small outer diameter, and there is a great difference between outer diameter φD1 of clip 10 and the outer diameter of the pipe, the sheet thickness of pipe clamp portion 11 of clip 10 becomes thick and difficult to bend. To accommodate this case, the outer diameter of the clip 10 of the present invention is made smaller than φD1, and the outer diameter of the plurality of ribs 16 which are formed on the outer circumference of pipe clamp portion 11 is made to be φD1. The thickness of pipe clamp portion 11 is therefore reduced, and as a result, it becomes easily bendable and can be placed in the same clamp 20 as were the clamps described earlier.

FIG. 15 is a front elevational view of a pipe P3 that has an outer diameter φd3, which is less than the outer diameter φd2 of pipe P2, and which is mounted using clip 10b of the second embodiment of the present invention.

Clamp 20 is the same clamp 20 explained above with reference to FIG. 11. The inner diameter of housing 23 is approximately equal to the outer diameter of pipe clamp portion 11 of clip 10 (which is approximately φD1). The inner diameter of clip 10b conforms to the outer diameter φd3 of pipe P3. The outer diameter of clip 10b is smaller than φD1.

Ribs 16 that extend in the axial direction are formed at three locations on the outer circumference of the pipe clamp portion 11. Each rib includes a tip which engages the channel or housing 23 of the clamp 20. The outer diameter of the rib 16 is φD1.

Thus clip goes 10b can be mounted in housing 23 of clamp 20, in the same manner as clip 10 in FIG. 11.

A pipe can also be mounted using clamp 20 only, without using clip 10.

FIG. 16 is a front elevational view of a pipe P4 having an outer diameter φD1, which is attached using clamp 20 only, without using clip 10. If the outer diameter of pipe P4 is greater than φd2, and is approximately equal to outer diameter φD1 of clip 10, pipe P4 can be mounted using clamp 20 only, without using clip 10.

If pipe P4 is mounted using clamp 20 only, the efficacy of preventing a horizontal slip, which is present when clip 10 is used, is lacking.

Clamp 20 may be mounted on pipe P4 and then attached to the panel. Or, clamp 20 may be attached to the panel first, and then pipe P4, having an outer diameter φD1, may be attached to clamp 20.

In the embodiments of the present invention, the inner diameter of pipe clamp portion 11 of clip 10 is smaller than the outer diameter of pipe P2 which is to be mounted; as a result, pipe P2 can be tightly held around its entire circumference, with the exception of the opening for inserting pipe P2.

Further, clip 10 has insert guide plates 12; as a result, pipe P2 can easily be inserted into pipe clamp portion 11. When clip 10 is mounted in clamp 20, insert guide plates 12 compress, by means of prongs 24, in a direction that narrows the open portion; as a result, the force holding the pipe tightly is increased. Also, clip 10 is held so that it does not rotate relative to clamp 20.

Prongs 24 of clamp 20 abut stoppers 13 of clip 10, and as a result, even if a force is applied to pipe P2 in the direction of removing the pipe from clamp 20, prongs 24 continue to abut stoppers 13 and cannot move along the outer circumference of pipe clamp portion 11. Therefore, pipe P2 is held and does not fall out.

Main body 22 of clamp 20 is held from both sides by means of slip-preventing plates 14 of clip 10, and as a result, clip 10 does not slip horizontally from the clamp in the axial direction.

When pipes having different diameters are mounted, the same clamp 20 is used, and by standardizing the outer diameter of clip 10, which is to be attached to clamp 20, and changing the inner diameter, pipes with different diameters can be mounted.

In addition, a large diameter pipe P4 can be mounted using clamp 20 only, without using clip 10, if its outer diameter is approximately equal to the inner diameter of housing 23 of clamp 20.

In one embodiment of the present invention, the clip 10 and clamp 20 are each formed as a resilient unitary body.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A clip for holding a tubular part, the clip being used in combination with a clamp for attaching to a workpiece, the clip comprising:
a cylindrical pipe clamp portion defining an open portion that is open along the axial direction of the cylindrical pipe clamp portion, the pipe clamp portion further defining an axial end;
wherein the open portion defines two circumferentially-opposing end portions extending in the axial direction; and further comprising:
an insert guide plate extending obliquely outwardly from each circumferentially-opposing end portion;
wherein the insert guide plates extend axially along the pipe clamp portion; and further comprising:
a slip-preventing plate extending widthwise from the axial end of the pipe clamp portion.

2. The clip claimed in claim 1, wherein:
the pipe clamp portion has an axial length; and
wherein the insert guide plates have the same axial length as the pipe clamp portion.

3. The clip claimed in claim 2, wherein:
the pipe clamping portion defines two axial ends; and
wherein a slip-preventing plate extends widthwise from each axial end.

4. The clip claimed in claim 3, further comprising:
a raised stopper formed on the pipe clamp portion adjacent to each circumferentially-extending end portion of the pipe clamp portion;
wherein the raised stoppers extend axially along the pipe clamp portion.

5. The clip claimed in claim 4, wherein the raised stoppers have the same axial length as the pipe clamp portion.

6. The clip claimed in claim 5, wherein:
the pipe clamp portion defines an outer circumferential surface; and further comprising:
a plurality of raised ribs extending radially outwardly from the outer circumferential surface and axially along the pipe clamp portion.

7. The clip claimed in claim 6, wherein the raised ribs have the same axial length as the pipe clamp portion.

8. The clip claimed in claim 7, wherein the clip is formed as a unitary resilient body.

9. A clamp assembly for holding a tubular part, comprising:
a clamp including a clamp portion and a locking portion for attaching to a workpiece; wherein
the clamp portion includes a main body defining a housing;
the clamp portion further including a top end formed on each side of the main body:
the main body defining a prong extending radially inwardly from each top end of the clamp portion, each prong defining an inside upper surface; and further comprising:
a clip having a cylindrical pipe clamp portion defining an open portion that is open along the axial direction of the cylindrical pipe clamp portion, the pipe clamp portion further defining an axial end;
wherein the open portion defines two circumferentially-opposing end portions extending in the axial direction; the clip further comprising:
an insert guide plate defining an outside lower surface and extending obliquely outwardly from each circumferentially-posing and portion;
wherein the insert guide plates extend axially along the pipe clamp portion; the clip further comprising:
a slip-preventing plate extending widthwise from the axial end of the pipe clamp portion;
wherein the pipe clamp portion of the clip is disposed in the clamp housing such that the outside lower surfaces of the insert guide plates abut respective inside upper surfaces of the prongs of the clamp, and such that the clip is prevented from rotating relative to the clamp.

10. The clamp assembly claimed in claim 9, wherein the insert guide plates are compressed by respective prongs of the clamp so as to narrow the width of the open portion.

11. The clamp assembly claimed in claim 10, wherein:
the main body of the clamp defines two axial ends;
the clip includes two slip-preventing plates;
one slip-preventing plate abuts one end of the main body of the clamp, and the other slip-preventing plate abuts the other end of the main body of the clamp; and
wherein the clip is held so that it does not slip horizontally relative to the clamp.

12. The clamp assembly in claimed in claim 11, wherein:
the clip further includes a raised stopper formed on the pipe clamp portion adjacent to each circumferentially-extending portion of the pipe clamp portion, the raised stoppers extending axially along the pipe clamp portion;
the prongs of the clamp define respective tips; and
wherein the tips of the prongs abut the stoppers of the clip so that the prongs cannot move outwardly, the opening cannot widen, and the clip cannot be removed from the clamp.

13. The clamp assembly claimed in claim 12, wherein:
the pipe clamp portion of the clip defines an outer circumferential surface upon which are formed a plurality radially outwardly-extending raised ribs, extending also in the axial direction along the pipe clamp portion, each rib having a tip;
the tips of the ribs abut the “U”-shaped housing of the clamp; and
wherein the clamp is able to accommodate tubular parts having smaller diameters than the tubular parts accommodated by pipe clamp portions not furnished with said ribs.

14. The clamp assembly claimed in claim 13, wherein the clip and the clamp are each formed as a unitary body out of resilient material.

15. A mounting structure for mounting a tubular component, comprising:
a clip holding the tubular component; and
a clamp holding the clip and having two axial ends;
wherein the clamp includes a clamp portion and a locking portion for attaching to a workpiece;
the clamp portion includes a main body defining a housing;
the clamp portion further includes a top end formed on each side of the main body;
the main body further including a prong extending radially inwardly from each top end of the clamp portion, each prong defining an inside upper surface;
the clip has a cylindrical pipe clamp portion defining an open portion that is open along the axial direction of the cylindrical pipe clamp portion, the pipe clamp portion further defining two axial ends;
the open portion defines two circumferentially-opposing end portions extending in the axial direction such that the tubular component may be inserted and held within the pipe clamp portion; the clip further comprising:
an insert guide plate defining an outside lower surface and extending obliquely outwardly from each circumferentially-opposing end portion;
wherein the insert guide plates extend axially along the pipe clamp portion; the clip further comprising:
a slip-preventing plate extending widthwise from each axial end of the pipe clamp portion;
wherein one slip-preventing plate abuts one end of the main body of the clamp, and the other slip-preventing plate abuts the other end of the main body of the clamp such that the clip is held so that it does not slip horizontally relative to the clamp; and
wherein the pipe clamp portion of the clip is disposed in the clamp housing such that the outside lower surfaces of the insert guide plates abut respective inside upper surfaces of the prongs of the clamp, and such that the clip is prevented from rotating relative to the clamp.

16. The mounting structure claimed in claim 15, wherein the inner diameter of the pipe clamp portion of the clip is smaller than the outer diameter of the tubular component.

17. The mounting structure claimed in claim 16, wherein:
the clip further includes a raised stopper formed on the pipe clamp portion adjacent to each circumferentially-extending portion of the pipe clamp portion, the raised stoppers extending axially along the pipe clamp portion;
the prongs of the clamp define respective tips;
the tips of the prongs abut the stoppers of the clip so that the prongs cannot move outwardly, the opening cannot widen, and the clip cannot be easily removed from the clamp; and
wherein the stoppers do not directly engage the tubular component.

18. The mounting structure claimed in claim 17, wherein:
the insert guide plates exert a retaining force upon the tubular component when the tubular component has been inserted into the clip;
the prongs of the clamp compress respective insert guide plates in a direction that narrows the open portion;
the retaining force upon the tubular component is enhanced by the cooperation of the prongs of the clamp with the insert guide plates; and
wherein the tubular component is not easily removed from the mounting structure.

19. The mounting structure claimed in claim 18, wherein the clip and the clamp are each formed as a unitary body from resilient material.

20. The mounting structure claimed in claim 18, wherein:
the main body of the clamp portion of the clamp defines a plurality of housings;
a clip is mounted in each housing; and
wherein the mounting structure may accommodate a plurality of tubular components.
